(19) United States
(12) Patent Application Publication
(10) Pub. No.: US 2011/0173778 A1
(43) Pub. Date: Jul. 21, 2011

(54) ERGONOMIC AUXILIARY HANDLE

(76) Inventor: Michael Wales, Riverside, CT (US)

(21) Appl. No.: 12/910,558

(22) Filed: Oct. 22, 2010

Related U.S. Application Data
(60) Provisional application No. 61/254,459, filed on Oct. 23, 2009.

(51) Int. Cl. B25G 1/00; B25G 3/00

(52) U.S. Cl. 16/426

(57) ABSTRACT

An auxiliary handle for use on tools or implements is provided herein. The auxiliary handle has a handle portion, a base portion, and an attachment portion for attaching the auxiliary handle to the shaft of a tool or implement. The handle portion has a body and a grip, the body being rotatably and slidably disposed in the base portion and may be adjusted into a variety of positions and/or orientations. The base portion is rotatably connected to the attachment portion.

### CROSS-REFERENCE TO RELATED APPLICATIONS

The present application claims the benefit under 35 U.S.C. §119(e) of the U.S. Provisional Patent Application Ser. No. 61/254,459, filed on Oct. 23, 2009, the content of which is incorporated herein by reference.

### FIELD OF THE INVENTION

The invention relates to ergonomic auxiliary handles for use with hand tools and hand held implements with a shaft, such as shovels, rakes, brooms, mops and other yard, shop and indoor tools.

### BACKGROUND OF THE INVENTION

Hand held implements, such as shovels, are among the simplest of tools and find widespread use throughout the world. However, it is widely recognized that the commonly used shovel, having a shaft-like handle extending from the working end of the tool, provides poor mechanical advantage for the user. A user wielding a straight handle shovel can experience injury, for example lower back injury, especially when moving heavy loads.

Previous attempts have been made to improve the working of such tools and hand-held implements by providing an auxiliary handle. Unfortunately, such auxiliary handles have exhibited one or more significant drawbacks and disadvantages. For example, many previously available devices required that the original handle of the implement be substantially modified before the auxiliary handle could be attached. Alternatively, some previously available devices can only be used with original handles which are specifically designed for such purposes. In either case, the end user is generally required to buy a completely new implement or new tool handle already fitted with ergonomic handles, or severely modify his old implements for use with the new auxiliary handle. Moreover, previously available devices often require fasteners for assembly.

The previously available devices are also generally fabricated out of metal components which, due to the environment in which many hand held implements are used, are subject to corrosion. Corrosion of metal parts results in weakening of the device and hindering or even arresting of the movement of articulating parts.

Most notably, the previous available devices were rigid, fixed-position handles. These handles only provided one or two degrees of freedom—typically limited to movement along the axis of and around the circumference of the shaft. This only provides the user with a limited number of possible gripping positions and therefore these previous devices provide only limited relief of the back and leg strain associated with the use of the implement alone.

In view of these drawbacks and disadvantages, it would be an advance in the art to provide an improved auxiliary handle for use with a variety of hand held implements.

### SUMMARY OF THE INVENTION

Accordingly, it is an object of the present invention to provide an ergonomic auxiliary handle that can be attached to any tool having an elongate shaft to provide leverage for using the tool, while allowing the user to assume a more ergonomic body position.

These and other objectives are achieved by providing an ergonomic auxiliary handle that can be quickly and securely, yet removably attached to a variety of tools. It is a further object of the present invention to provide this handle with several adjustment means so that it may be moved or adjusted into any position that would suit the user's needs. Yet a further object of the present invention is to provide an ergonomic auxiliary handle that is constructed of durable and rust-proof materials so that they do not need to be replaced frequently.

Other objects, features and advantages according to the present invention will become apparent from the following detailed description of several embodiments of the invention as described in conjunction with the drawings.

### BRIEF DESCRIPTION OF THE DRAWINGS

FIG. 1 is a front perspective view of an embodiment of the auxiliary handle of the present invention.

FIG. 2 is a back perspective view of an embodiment of the auxiliary handle of the present invention.

FIG. 3 is an exploded view of an embodiment of the base and attachment portions of an auxiliary handle of the present invention.

FIG. 4 is a partial exploded view of an embodiment of the attachment portion of an auxiliary handle of the present invention.

FIG. 5 is a perspective view of an embodiment of an auxiliary handle of the present invention, shown on the shaft of a tool or implement, and illustrating the adjustment capabilities of the auxiliary handle.

FIG. 6A is a perspective view of an embodiment of an auxiliary handle of the present invention shown on the shaft of a tool or implement, and illustrating one of the adjustment capabilities of the auxiliary handle.

FIG. 6B is a perspective view of an embodiment of an auxiliary handle of the present invention shown on the shaft of a tool or implement, and illustrating one of the adjustment capabilities of the auxiliary handle.

FIG. 6C is a perspective view of an embodiment of an auxiliary handle of the present invention shown on the shaft of a tool or implement, and illustrating one of the adjustment capabilities of the auxiliary handle.

FIG. 7 is a front perspective view of an additional embodiment of an auxiliary handle of the present invention.

### DETAILED DESCRIPTION OF THE INVENTION

The disclosed invention is an ergonomic auxiliary handle that can be retrofitted onto common yard and home tools to improve the ergonomics and usability of the tools. The ergonomic handle of the present invention may be used with any implement or tool (not shown) with a long shaft, such as but not limited to a rake, shovel, snow shovel, mop, hoe, spade, paint roller and broom. The shaft has a first end located near the tool of the implement and a second end located away from the tool. The tool may be a rake head, shovel head, bristles of a broom, mop head, hoe blade, spade blade, etc. In addition, two ergonomic handles may be used at one time with the same tool or implement. This takes advantage of existing leverage while providing additional leverage reliving back pain and over-strenuous activity. The ergonomic auxiliary handle is adjustable, and can be used anywhere where an additional handle may be useful, both indoors and outdoors, such as on rakes, brooms, shovels, power washers, and weed-trimmers.

The ergonomic auxiliary handles of the present invention have several notable advantages, including: (1) they create leverage on all tools with handles; (2) they eliminate back and leg strain by allowing the user to stand more upright and grasp the tool in a more ergonomic manner; (3) they provide a cushioned grip so that gloves are no longer necessary and blisters are no longer a problem; (4) they fit all handle tools, such as rakes, shovels, hoes, brooms, snow shovels, pole saws, pruners, and extensions for paint rollers, light bulb changers, dusters etc.; (5) they quickly, easily and securely clamp onto all handles; (6) the handles and attachment means are made out of plastics or other rust-proof materials; and (7) the handles are adjustable with at least 10 degrees of freedom, providing an infinite number of gripping positions.

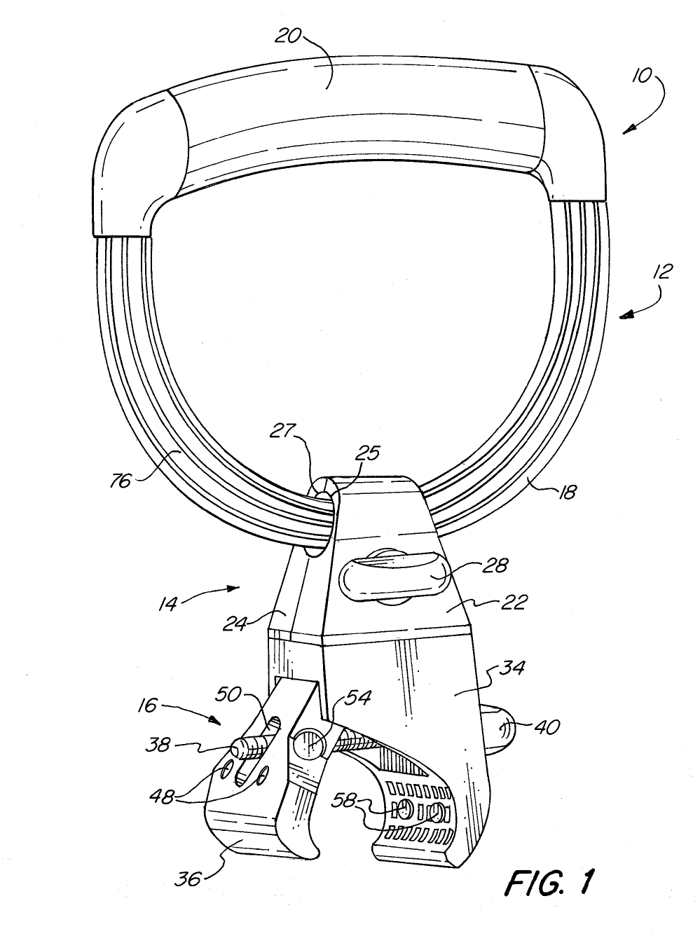

Turning now to the figures, the ergonomic auxiliary handle 10 of the present invention is shown in FIG. 1. The auxiliary handle 10 has a handle portion 12, a base portion 14 and an attachment portion 16 for releasably attaching the ergonomic handle to the shaft of a tool or implement. The handle portion 12 includes a body 18 and a grip 20. The grip 20 may be rotatably attached to the body 20, providing one adjustment capability. In addition, the grip may be made of foam or other supple material and may also be contoured to correspond to the shape of a user's hand to increase comfort.

The body 18 of the handle portion 12 may be slidably and/or rotatably disposed in the base portion 14. In a preferred embodiment, the body 18 is both slidably and rotatably disposed in base portion 14. In addition, the body 18 may be substantially curved such that the handle portion 12 may slide a full 180 degrees within the base portion 14.

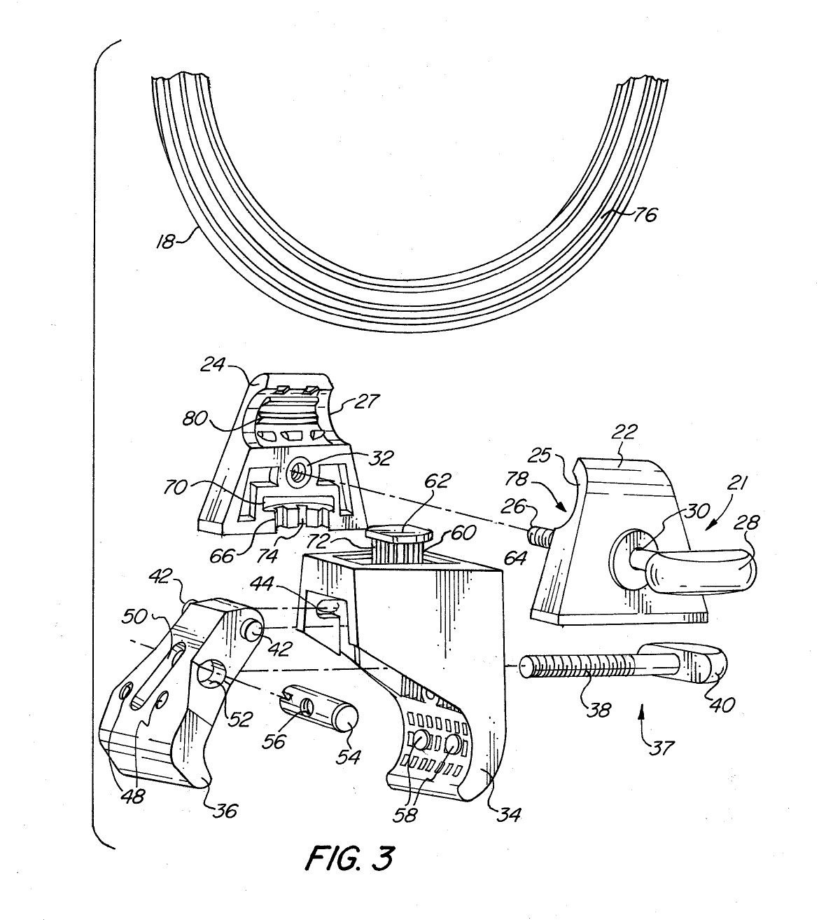

Base portion 14 includes a first yoke portion 22, a second yoke portion 24 and an adjuster 21. In one embodiment, adjuster 21 may be screw 26 which terminates in a knob 28. As can be seen in FIG. 3, the inner surface of each yoke portion 22, 24 is provided with a substantially crescent-shaped notch 26, 27. When fitted together, the crescent-shaped notch 26, 27 of each yoke portion 22, 24 creates an aperture through for accepting at least a portion of the handle portion body 18.

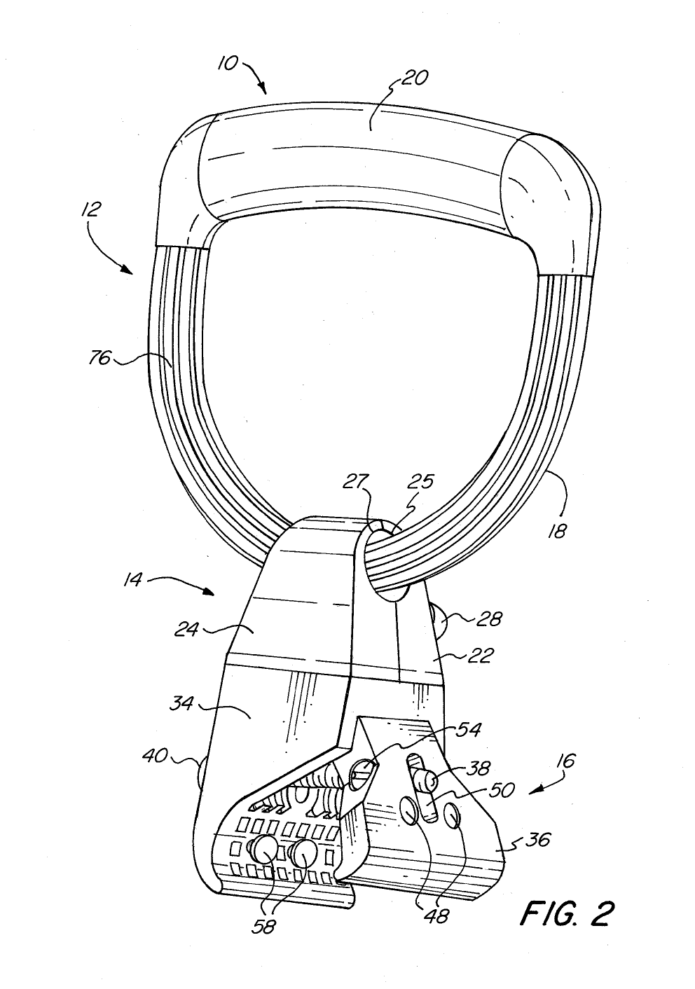

Additionally, the first yoke portion 22 is provided with a hole 30 therethrough for passing the adjustment screw 26 and the inner surface of the second yoke portion 24 is provided with an internally threaded hole 32 for threadably engaging the adjustment screw. Aside from hole 30 and threaded hole 32, the inner surfaces of the first and second yoke portions 22, 24 are substantially identical. Knob 28 prevents the adjustment screw from being pulled through the hole 30 in the first yoke portion 22. When the adjustment screw 26 is passed through hole 30 and threaded into hole 32, the first and second yoke portions 22, 24 are brought into abutment and can be tightly fitted together as the adjustment screw 26 is tightened. While the two yoke portions 22, 24 create a pyramidal shape when brought together, it is understood that any other suitable shape or design may be used without departing from the spirit of the invention. It is also contemplated that yoke portions 22, 24 may be formed as a single piece, with an aperture defined therein for accepting at least a portion of the handle portion body 18, instead of two separate pieces as shown in FIGS. 1-3.

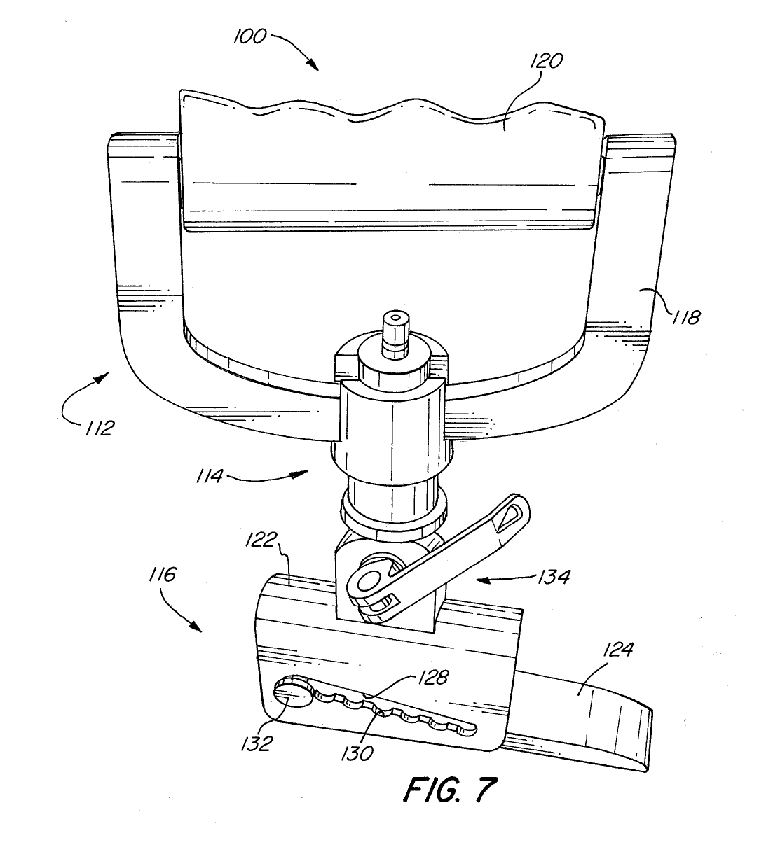

The attachment portion 16 may be any suitable attachment means that allows for easy and quick attachment and removal of the auxiliary handle 10 to the shaft of a tool or implement. In one embodiment, the attachment portion 16 may include a first jaw 34 and a second jaw 36 for releasably clamping around the shaft of a tool or instrument. For example, the attachment portion 16 may be a simple collar that “snaps” or slides onto the shaft of a tool or instrument and is held in place by friction. Or, the attachment portion may be a C-clamp. Other alternative embodiments are contemplated and will not depart from the spirit of the invention. The attachment portion 16 may also include an adjuster 37. In the embodiment shown in FIGS. 1-5, the adjuster 37 is an adjustment screw 38, which terminates in a knob 40. Alternatively, the adjuster may be a strap for tightening the attachment portion 16 onto the shaft of a tool or instrument. Or, as shown in FIG. 7, as will be described further below, the attachment portion may consist of a cuff and adjuster, which may be a lever arm. Other embodiments are contemplated herein.

Turning back to the embodiment shown in FIGS. 1-5, the second jaw 36 is rotatably connected to the first jaw 34 via two studs 42 on the second jaw 36 that slide into tracks 44 on the inner surface of first jaw 34. The tracks 44 may be shaped like an inverted “L”. The two studs 42 may be formed integral with the second jaw 36. Alternatively, the second jaw 36 may be rotatably connected to the first jaw 34 via a single pivot pin that passes through corresponding through-holes in both the first and second jaws 34, 36.

Each of the first and second jaws 34, 36 are also provided with a longitudinal slot 48, 50 for accommodating the adjustment screw 38 therein. A transverse bore 52 also passes through second jaw 36 and bisects the longitudinal slot 50. An adjustment nut 54 having a threaded transverse hole 56 is rotatably disposed in the transverse bore 52. When assembled, adjustment screw 38 passes through the longitudinal slot 48 in the first jaw 34, is threaded into the threaded transverse hole 56 in the adjustment nut 54 and then passes out of the longitudinal slot 50 in the second jaw 36.

Because adjustment nut 54 is rotatably disposed in the second jaw 36, it allows the adjustment screw 38 to be tilted or pivoted within the longitudinal slot 48. Thus, when the adjustment screw 38 is tilted or pivoted within the longitudinal slot 48 of the first jaw 34, adjustment nut 54 will correspondingly rotate within the second jaw 36. This allows for further range of motion of the second jaw 36 allowing for the attachment portion 16 to be adjusted to fit a wide range of diameters. Moreover, when the knob 40 of the adjustment screw 38 is tilted upwards toward the handle portion 12, the second jaw 36 naturally pivots inward towards the first jaw 34, providing additional wedging or clamping force. In addition, this has the added benefit of drawing the adjustment screw 38 upwards toward the upper, inner surface of the attachment portion 16 and protecting the surface of the shaft of the tool or implement. First jaw 34 may also be provided, around the area of the slot 48, with a wedged inset 49 to allow more operating room for knob 40.

One or more pads 58 may also be provided on the inner surface of each jaw member. The pads 58 may be made of any suitable material, such as a soft plastic or foam, so as to not only prevent damage to the shaft of the tool or implement, but also add additional grip and help to further secure the jaws to the shaft of the tool or implement. The pads 58 may simply be pressed into holes 46, 48 in the first and second jaws 34, 36, respectively. Alternatively, the inner surfaces of the jaws 34, 36 may be lined to add additional grip.

The base portion 14 is rotatably attached to the attachment portion 16 by means of a neck 60 which terminates in a shoulder 62. The internal surfaces of each of the yoke portions 22, 14 of the base portion 14 are each provided with a corresponding collar 64, 66 and shelf 68, 70 for accommodating the neck 60 and shoulder 62 of the attachment portion 16. In operation, if the adjustment screw 26 of the base portion 14 is loosened, a user may rotate the base portion 14 with respect to the attachment portion 16. While not required, the neck may also be provided with a plurality of teeth 72 for mating with a plurality of teeth 74 on each collar 64, 66 of the base portion 14. These mating teeth 72, 74 provide a discrete number of preset locations into which the base portion 14 may be positioned and provide additional strength to prevent undesirable rotation of the base portion 14 with respect to the attachment portion 16 while the auxiliary handle is in use.

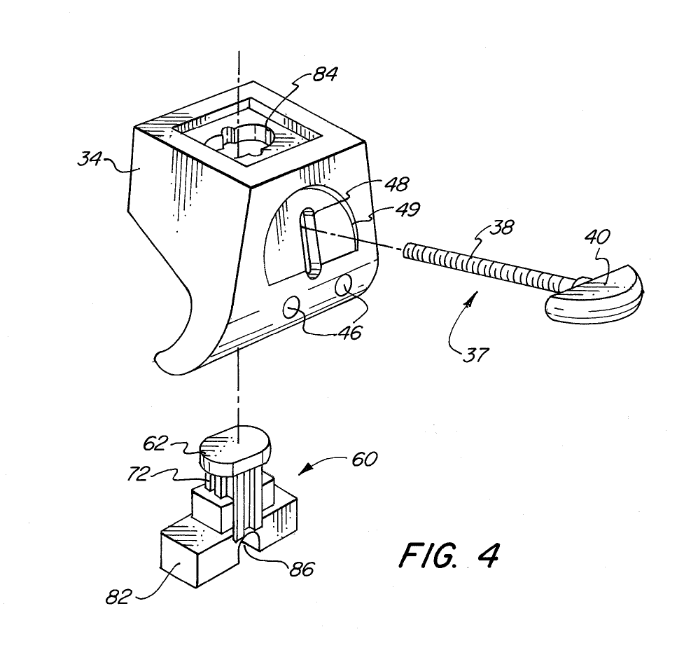

In one embodiment, neck 60 may be integral with the attachment portion 16. As shown in FIG. 4, neck 60 of the attachment portion 16 may also be an independent, separable piece. In this embodiment, the neck 60 may be shaped as an inverse “T” with a flange 82 at the base. This flange 82 prevents the neck from being completely pulled through the insertion hole 84 provided in the first jaw 34. In addition, flange 82 may be provided with a channel 86 for accommodating the adjustment screw 38 on the underside of the attachment portion 16. When the adjustment screw 38 is at least partially disposed in this channel 86, it prevents the screw 38 from being able damage or mar the surface of the shaft of the tool or implement. Having the neck 60 as a separable piece provides the advantage of making the neck 60 out of a different, preferably a more robust material than the rest of the auxiliary handle 10. Because the neck 60 bears a high load when the auxiliary handle is in use, it is desirable to make it out of a stronger material. For example, in one embodiment the neck 60 is made of a polyamide (PA) plastic. The neck 60 may also be made out of metal.

Similarly, the body 18 may also be provided with at least one groove 76 running along its length. This at least one groove 76 mates with at least one ridge 78, 80 disposed on the inner surface of the crescent-shaped notch 25, 27, respectively, of each yoke portion 22, 24 of the base 14. The at least one ridge 78, 80 is preferably substantially straight, but may be slightly curved to correspond to the curvature of at least one groove 76. Alternatively, the inner surface of the crescent-shaped notch 25, 27 of each yoke portion 22, 24 of the base 14 may be provided with at least one groove and the body 18 may be provided with at least one mating ridge. Preferably, the body 18 and the inner surface of the crescent-shaped notch 25, 27 of each yoke portion 22, 24 of the base 14 are provided with more than one groove 76 and ridge 78, 80, respectively.

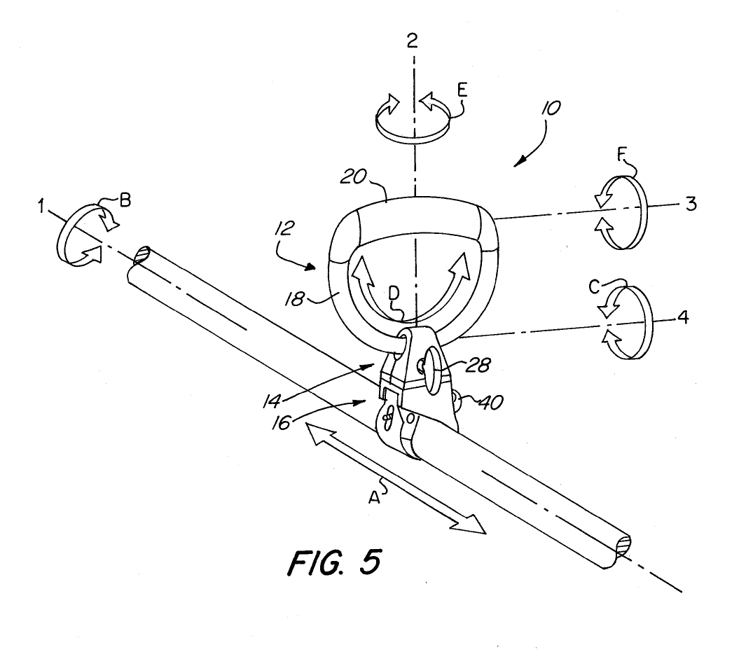

This system of at least one groove and at least one ridge provides several advantages. First, if the user desires to slide the handle 12 in the direction D as shown in FIG. 5, the at least one mating groove 76 and ridge 78, 80 provides a “track” in which the handle 12 may slide. Second, when mated together, the at least one groove 76 and ridge 78, 80 prevents undesirable rotation of handle 14 in direction D while the auxiliary handle 10 is in use. Third, when more than one groove 76 and ridge 78, 80 are provided, these mating grooves 76 and ridges 78, 80 also provide certain preset positions that the handle 12 may rotate with respect to the base 14 in direction C. If no grooves 76 or ridges 78, 80 are provided, the handle 12 may continuously rotate in the base 14 in direction C into any desired position.

The ergonomic auxiliary handle 10 may be made out of any suitable material, such as molded plastic or metal. Preferably, the auxiliary handle 10 is made of a plastic, such as regrind plastic, so that it will not rust due to outdoor use. As stated above, the grip portion may be made out of foam for comfort purposes.

Notably, the attachment portion 16 of the auxiliary handle 10 has several advantages. First, no tools such as wrenches or screwdrivers are necessary to attach or release the auxiliary handle 10 to the shaft of a desired tool or implement. Due to the novel design, all that is required is for a user to loosen and/or tighten the adjustment screw 18 by means of knob 40. Second, the attachment portion 16 does not require any modification of the shaft of the tool or instrument in order to attach the auxiliary handle 10. As discussed above, one disadvantage of prior art auxiliary handles is that they must be screwed into the shaft of the desired tool, or the attachment means has burrs or teeth that dig into the shaft, both causing damage to the shaft of the tool itself. Third, the attachment portion 16 is completely and easily releasable from the shaft of the desired tool or implement. Because the adjustment portion 16 is not permanently affixed to the shaft, a user does not need a separate auxiliary handle 10 for each tool or implement on which an auxiliary handle is desired. The attachment portion 16 allows the auxiliary handle 10 to be a stand-alone device.

As illustrated in FIG. 5, the ergonomic auxiliary handle 10, in a preferred embodiment, has 6 degrees of adjustment capability. First, the auxiliary handle 10 may be positioned anywhere along the axis 1, defined by the shaft of a tool or implement, by loosening adjustment screw 38 of the attachment portion 16 via knob 40, moving the auxiliary handle 10 along the axis 1 of the shaft in the direction of arrow A, and then tightening the adjustment screw 38 to secure it in place. Second, in a similar fashion, the auxiliary handle 10 may be rotated 360 degrees about the axis 1 of the shaft in the direction of arrow B.

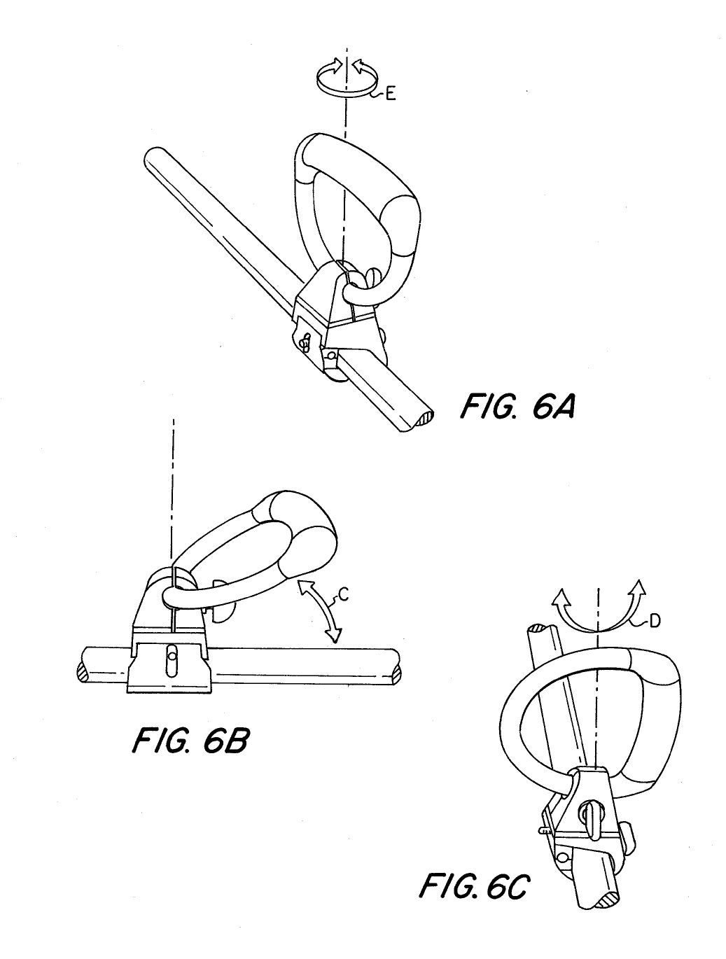

Third, the handle portion 12 may be rotated about axis 4, which passes through the aperture defined in the base portion, in the direction of arrow C by loosening adjustment screw 26 of the base portion 14 via knob 28 and rotating the handle portion 12 to the desired angle, in either direction, and then tightening the adjustment screw 26 to secure it in place. Depending on the size and shape of the handle portion 12, base portion 14 and attachment portion 16, the handle portion 12 may be rotated at least 180 degrees, and likely at least 270 degrees, around axis 4. Preferably, the handle portion 12 may be rotated until it touches the shaft of the tool on either side of the attachment portion 16. If the body 18 of the handle portion 12 and the inner surface of the crescent-shaped notch 25, 27 are provided with corresponding grooves 76 and ridges 78, then the handle portion 12 must be rotated into one of the “preset” positions. If not, then the handle may rotate freely into any position. This is further illustrated in FIG. 6B.

Fourth, the handle portion 12 may be slid in the direction of arrow D by loosening adjustment screw 26 of the base portion 14 via knob 28 and sliding the handle portion 12 to the desired position, in either direction of arrow D, and then tightening the adjustment screw 26 to secure it in place. If the body 18 of the handle portion 12 and the inner surface of the crescent-shaped notch 25, 27 are provided with corresponding grooves 76 and ridges 78, then the grooves and ridges provide a track within which the body 18 slides. This is further illustrated in FIG. 6C.

Fifth, the base portion 14 may be rotated around axis 2 with respect to the attachment portion 18 in the direction of arrow E by loosening adjustment screw 26 of the base portion 14 via knob 28 and rotating the handle portion 12 to the desired position, in either direction of arrow E, and then tightening the adjustment screw 26 to secure it in place. This is further illustrated in FIG. 6A.

Last, the grip 20 of the handle portion 12 may be rotated around axis 3 with respect to the body 18 in the direction of arrow E.

To increase the usability of a tool or implement, two auxiliary handles may be used in accordance with the invention

In another embodiment of the auxiliary handle 100, shown in FIG. 7, the attachment means 116 is a clamp having a cuff 122 and a ratcheting lever arm 124 that allows the handle to be attached to shafts of a variety of diameters. The auxiliary handle 100 has a handle portion 112 with a body 118 and a contoured grip 120, a base portion 114 and an attachment portion 116. Each side of the cuff 122 is provided with a diagonal slot 128 having a plurality of teeth 130. The lever arm 124 is preferably wedge-shaped, and is provided with a pin 132 for mating with teeth 130. In operation, the shaft of a tool or handle is slid through the cuff 122 and a user grasps the end of the lever arm 124 and positions the pin 132 into the tooth 130 which will provide a tight fit against the diameter of the shaft of the tool. The user then presses the lever arm 124 upwards toward the handle portion 112 to lock the shaft into the cuff 122. The base portion 114 is provided with an adjustment mechanism 134 for allowing the handle portion 112 to rotate in the direction of arrow E. In this embodiment, the adjustment mechanism 134 cam and lever type mechanism (similar to a bicycle quick release), but other mechanisms are contemplated. Handle portion 112 may also slide in the direction of arrow D and rotate in the direction of arrow C.

The attachment means may also include, inter alia, a ring slideable onto the shaft with a set screw, a ring slideable onto the shaft where the ring can be tightened onto the shaft, or a spring loaded clamp.

It should be noted that the terms “first”, “second”, and “third”, and the like may he used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. An auxiliary handle comprising:
a handle portion, a base portion, and an attachment portion;
said handle portion having a body and a grip;
said curved body being rotatably and slidably disposed in an aperture defined by said base portion;
said base portion being rotatably connected to said attachment portion; and
said attachment portion being adapted for releaseably attaching to a shaft of a tool or implement.

2. The auxiliary handle of claim 1 wherein said body is curved.

3. The auxiliary handle of claim 1 wherein said attachment portion further comprises a first adjuster.

4. The auxiliary handle of claim 1 wherein said base portion further comprises a second adjuster.

5. The auxiliary handle of claim 1 wherein said attachment portion has a first jaw and a second jaw.

6. The auxiliary handle of claim 5 wherein said attachment portion is a cuff.

7. The auxiliary handle of claim 5 wherein said attachment portion is a C-clamp.

8. The auxiliary handle of claim 5 wherein said second jaw is hingedly connected to said attachment portion.

9. The auxiliary handle of claim 5 wherein each of said first jaw and said second jaw has a hole passing therethrough for accommodating a first adjuster therein.

10. The auxiliary handle of claim 5 wherein each of said first jaw and second jaw has a longitudinal slot therein for accommodating a first adjuster therein.

11. The auxiliary handle of claim 10 wherein said first adjuster comprises a screw.

12. The auxiliary handle of claim 11 wherein said second jaw has a transverse bore therethrough that bisects said longitudinal slot and an adjustment nut rotatably disposed in said transverse bore, said adjustment nut having an internally threaded transverse hole for threadably engaging said screw.

13. The auxiliary handle of claim 1 wherein said grip is rotatably connected to said curved body.

14. The auxiliary handle of claim 1 wherein said base portion comprises a first yoke portion and a second yoke portion.

15. The auxiliary handle of claim 14 wherein each of said first and second yoke portions has a substantially crescent-shaped notch therein.

16. The auxiliary handle of claim 15 wherein said curved body has at least one groove disposed therein and said notch of each of said first and second yoke portions has at least one ridge disposed thereon for mating with said at least one groove.

17. The auxiliary handle of claim 14 wherein said first yoke portion has a hole therein for receiving a second adjuster therethrough and said second yoke portion has a threaded hole therein for threadably engaging said second adjuster.

18. The auxiliary handle of claim 1 wherein said base portion is rotatable 360 degrees with respect to said attachment portion.

19. The auxiliary handle of claim 1 wherein said handle portion is slidable 180 degrees with respect to said base portion.

20. The auxiliary handle of claim 1 wherein said handle portion is rotatable at least 180 degrees with respect to said base portion.

21. The auxiliary handle of claim 20 wherein said handle portion is rotatable 270 degrees with respect to said base portion.

22. An auxiliary handle comprising:
a handle portion, a base portion, and an attachment portion;
said handle portion having a body and a grip;
said base portion being rotatably connected to said attachment portion; and
said attachment portion being adapted for releaseably attaching to a shaft of a tool or implement.

23. The auxiliary handle of claim 22 wherein said base portion is rotatable 360 degrees with respect to said attachment portion.

24. The auxiliary handle of claim 22 wherein said attachment portion further comprises a first adjuster.

25. The auxiliary handle of claim 22 wherein said base portion further comprises a second adjuster.

26. The auxiliary handle of claim 22 wherein said body of said handle portion is rotatably disposed in said base portion.

27. The auxiliary handle of claim 26 wherein said handle portion is rotatable at least 180 degrees with respect to said base portion.

28. The auxiliary handle of claim 27 wherein said handle portion is rotatable 270 degrees with respect to said base portion.

29. The auxiliary handle of claim 22 wherein said body of said handle portion is slidably disposed within said base portion.

30. The auxiliary handle of claim 29 wherein said handle portion is slidable at least 180 degrees with respect to said base portion.

31. The auxiliary handle of claim 22 wherein said attachment portion has a first jaw and a second jaw.

32. The auxiliary handle of claim 31 wherein said attachment portion is a cuff.

33. The auxiliary handle of claim 31 wherein said attachment portion is a C-clamp.
